(19) United States
(12) Patent Application Publication
(10) Pub. No.: US 2025/0324239 A1
(43) Pub. Date: Oct. 16, 2025

(54) System and methods for remote mobile device type determination using multi-input data analysis

(71) Applicant: One Layer Ltd., Tel Aviv (IL)

(72) Inventors: Roy Shapira, Ramat Hasharon (IL); Ido Shaked, Kibbutz Nir Eliyahu (IL); Liron Ben Horin, Ramat Hasharon (IL); Or Yakov Turgeman, Ramat Hasharon (IL)

(73) Assignee: One Layer Ltd., Tel Aviv (IL)

(21) Appl. No.: 18/634,945

(22) Filed: Apr. 14, 2024

(51) Int. Cl. H04W 8/24; G16Y 10/75

(52) U.S. Cl. CPC H04W 8/24; G16Y 10/75

(57) ABSTRACT

Methods and systems for determining the type of a remote mobile device by combining multiple types of data sets. The system collects various types of data sets, such as data sets associated with identity information, traffic patterns, control signaling, and application data associated with a remote mobile device from a radio access network and a packet core. This data is processed using a machine learning model, or using other processing techniques, to generate an output data set, which is used to determine the device type. The determination is more accurate and consistent than using only one type of data set. The system can be implemented in various environments, including local servers, cloud-based servers, hybrid servers, and distributed servers. The service can be provided to clients as a cloud service, where clients provide a mobile number, and the service provider handles the data collection, processing, and device type determination.

### TECHNICAL FIELD

This application relates generally to systems and methods for identifying and categorizing remote devices.

### BACKGROUND

In today's interconnected world, the ability to accurately identify and categorize remote mobile devices is of paramount importance. The proliferation of mobile devices, including smartphones, tablets, Internet of Things (IoT) devices, and personal computers, has led to an increasingly complex digital landscape. This complexity underscores the need for robust and reliable methods for device identification. Accurate device identification is crucial for a variety of reasons, with security being at the forefront. Ensuring the integrity of network communications is vital. The device that a system is communicating with needs to be exactly what it purports to be. Any discrepancy can pose significant security risks, including unauthorized access, data breaches, and cyber threats. Accurate device identification can help mitigate these risks by enabling the implementation of device-specific security protocols and measures. Beyond security, device identification is also important for maintenance and tracking purposes. Different devices may require different maintenance strategies, and tracking device usage can provide valuable insights for network planning and resource allocation. Despite the clear need for accurate device identification, current technologies often fall short: existing methods often rely on a single type of data set, such as device identifiers or traffic information. However, these methods may not provide a sufficiently accurate identification of the device type. For example, device identifiers can be spoofed, and traffic patterns can vary greatly even for the same type of device. The dynamic nature of mobile devices, with new types being introduced and old ones becoming obsolete, poses a challenge for current identification technologies. A method that works well for one type of device may not work as well for another, leading to inconsistencies and inaccuracies in device identification. Given these challenges, there is a clear need for a more robust and accurate method for remote device identification.

### SUMMARY

One embodiment is a method for remotely determining the type of a mobile device by processing multiple types of inputs. The method involves: receiving at least two types of data sets associated with the remote mobile device from a radio access network (RAN) and a packet core, in which each data set type provides a respective type of clue about the mobile device type, then processing these data sets using a data processing technique to generate an output data set, and then determining the type of mobile device that best describes the remote mobile device using the output data set. As a result of this processing, the determination is more accurate and/or consistent than a similar determination using only one type of data set as an input.

One embodiment is a method for training and employing a machine learning model in conjunction with processing multiple types of inputs to remotely determine mobile device type. The method involves: receiving a plurality of data sets associated with multiple remote mobile devices from a radio access network (RAN) and a packet core, in which each data set provides clues about the mobile device types; preprocessing each type of received data sets separately to make them operative for training; training a suitable machine learning model using the preprocessed data sets to discern patterns and correlations between different data features and mobile device types; evaluating the performance of the trained model using at least one validation technique; and fine-tuning the model parameters and/or architecture based on the evaluation results to optimize performance. The method further involves: deploying the trained model for use in determining the type of mobile devices based on new incoming data sets of different types.

One embodiment is a system operative to process multiple types of inputs to remotely determine mobile device type. The system comprises: a receiver sub-system configured to receive at least two types of data sets associated with the remote mobile device from a radio access network (RAN) and a packet core, in which each data set type provides a respective type of clue about the mobile device type; a computer comprising a memory module operative to store machine-readable code and related data in conjunction with operating a machine learning model operative to process the at least two types of data sets, thereby generating an output data set; and a determination component configured to determine the type of mobile device that best describes the remote mobile device using the output data set. As a result of this processing process, the determination is more accurate and/or consistent than a similar determination using only one type of data set as an input.

### BRIEF DESCRIPTION OF THE DRAWINGS

The embodiments are herein described by way of example only, with reference to the accompanying drawings. No attempt is made to show structural details of the embodiments in more detail than is necessary for a fundamental understanding of the embodiments. In the drawings:

FIG. 1 illustrates one embodiment of a system for remotely determining the type of a mobile device;

FIG. 2 illustrates one embodiment of conveying different types of data sets to be used for remotely determining the type of a mobile device;

FIG. 3 illustrates one embodiment of a system operative to process multiple types of inputs to remotely determine mobile device type;

FIG. 4 illustrates one embodiment of a method for processing multiple types of inputs to remotely determine mobile device type;

FIG. 5 illustrates one embodiment of a method for training and employing a machine learning model in conjunction with processing multiple types of inputs to remotely determine mobile device type; and

FIG. 6 illustrates one embodiment of a multi-stage processing method where each category of input data sets is processed by its respective model and then a final model processes all the intermediary results to determine the type of mobile device.

### DETAILED DESCRIPTION

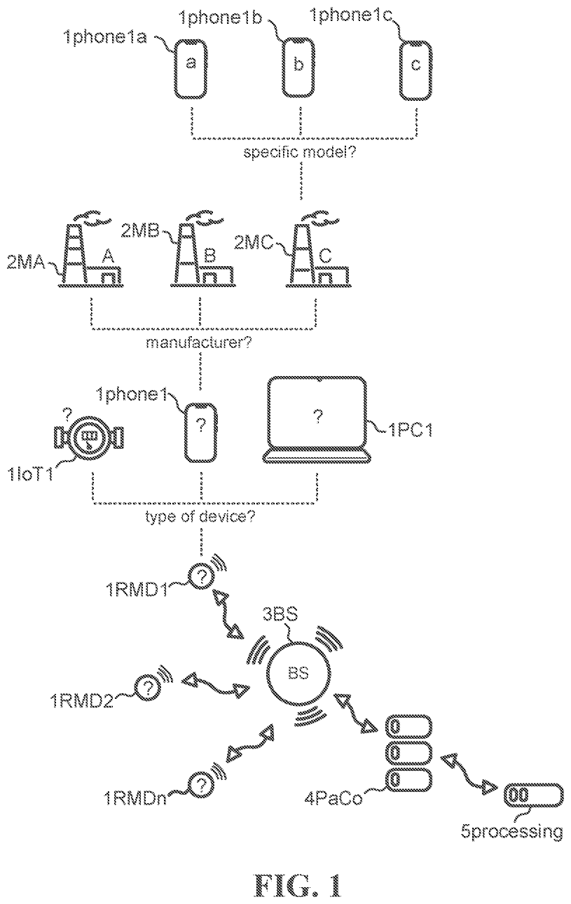

FIG. 1 illustrates one embodiment of a system for remotely determining the type of a mobile device (e.g., category, model, manufacturer). The system is associated with a Radio Access Network (RAN) 3BS and a packet core 4PaCo, to which multiple remote mobile devices 1RMD1, 1RMD2, 1RMDn are currently and/or were previously attached. The figure also shows various types of mobile devices, including smartphones 1phone1, Internet of Things (IoT) devices 1IoT1, and personal computers and/or laptops 1PC1, in which any one of the device types may be the actual type to which device 1RMD1 belongs. Additionally, specific models of smartphones 1phone1a, 1phone1b, 1phone1c are depicted, in which any one of the specific models of smartphones may be explicitly associated with smartphone 1phone1. It's important to note that there are also specific models or types associated with the other devices such as the Internet of Things (IoT) device 1IoT1 and computers/laptops 1PC1. These specific models or types, although not explicitly shown in FIG. 1, play a role in the operation of these devices. The figure also includes representations of different manufacturers 2MA, 2MB, 2MC. While any one of manufacturers 2MA, 2MB, and 2MC may be explicitly associated with the mobile device 1phone1, it's important to note that there are also manufacturers associated with the other devices such as the Internet of Things (IoT) device 1IoT1 and computers/laptops 1PC1. These manufacturers, although not explicitly shown in FIG. 1, play a role in the production and/or operation of these devices.

It is noted that the term “mobile device” is not limited to the devices explicitly shown in FIG. 1, and is intended to encompass a wide range of devices capable of wireless communication and network connectivity to the Radio Access Network (RAN) and/or packet core. This includes, but is not limited to: Tablets: these are portable devices larger than smart phones, typically with a touch screen interface, internet access, and an operating system capable of running downloaded apps. Feature phones: these are basic mobile phones that incorporate features such as the ability to access the internet and store and play music but lack the advanced functionality of a smartphone. Wearables: these are smart electronic devices that can be worn on the body as accessories or implants, such as smart watches and fitness trackers. Notebooks: these are lightweight and portable personal computers, more compact than laptops but still providing similar functionality. Any other portable and/or non-portable electronic device capable of wireless communication and network connectivity to the RAN and/or packet core.

It is noted Internet of Things (IoT) devices come in a wide variety of options and are designed to serve numerous functions. They can range from everyday household items like smart thermostats and refrigerators to industrial tools like predictive maintenance equipment. In the context of FIG. 1, the IoT device 1IoT1 could represent a variety of such devices, including a water meter. Water meters are an example of how IoT devices can be used for utility management. These smart meters can provide real-time monitoring of water usage, detect leaks, and even provide predictive analysis for future consumption. This data can be transmitted wirelessly to a central system, allowing for efficient resource management and timely billing without the need for manual meter readings.

In one embodiment, at least one of three key aspects is to be determined for the remote mobile device 1RMD1: Type: This may refer to the general category of the device, such as whether it's a smartphone 1phone1, an Internet of Things (IoT) device 1IoT1, a personal computer, a laptop 1PC1, or another type of mobile device. Model: this refers to the specific model of the device within its type. For example, if the device is a smartphone 1phone1, the model could be a specific version of a smartphone produced by a certain manufacturer. Manufacturer: this refers to the company or entity that produced the device. For example, if the device is a smartphone, the manufacturer could be a well-known smartphone company.

The Radio Access Network (RAN) 3BS is a critical part of a mobile telecommunication system. It includes the base stations (such as cell towers) and antennas that connect mobile devices to the network. There are several types of RANs, each designed to support different wireless network standards: GSM (Global System for Mobile Communications): this is the most widely used 2G system and uses different frequency bands for uplink and downlink data transmission. CDMA (Code Division Multiple Access): this is a type of 2G and 3G network standard that assigns a unique code to each call to differentiate it from others on the same network. LTE (Long Term Evolution): this is a 4G wireless communications standard developed by the 3rd Generation Partnership Project (3GPP) that's designed to provide up to 10× the speeds of 3G networks for mobile devices. 5G NR (New Radio): This is the global standard for a unified, more capable 5G wireless air interface. It delivers significantly faster and more responsive mobile broadband experiences, and extend mobile technology to connect and redefine a multitude of new industries. Wi-Fi: while not traditionally classified as a RAN, Wi-Fi networks also provide wireless access to devices, typically in local area networks such as a home or office. Each type of RAN, and other types not described above, supports different data transmission technologies and has its own advantages and disadvantages in terms of coverage, speed, and reliability.

The packet core, also known as the Evolved Packet Core (EPC) in 4G LTE networks or the 5G Core (5GC) in 5G networks, is a key component of the mobile network infrastructure. It is responsible for routing data packets across the network and to other networks. The following are some examples of different options for packet cores: GPRS Core Network (GCN): this is used in 2G and 3G networks, and includes components like the Serving GPRS Support Node (SGSN) for session management and the Gateway GPRS Support Node (GGSN) for interfacing with other networks. Evolved Packet Core (EPC): this is used in 4G LTE networks, and includes components like the Mobility Management Entity (MME) for signaling, the Serving Gateway (S-GW) for data transfer, and the Packet Data Network Gateway (P-GW) for interfacing with other networks. 5G Core (5GC): this is used in 5G networks, and introduces a service-based architecture where network functions are modular and can be independently deployed. Key components include the Access and Mobility Management Function (AMF), Session Management Function (SMF), and User Plane Function (UPF). Non-Standalone (NSA) 5G Core: in this option, 5G New Radio (NR) is used for the radio access network, but the core network is the same as the 4G EPC. This allows operators to leverage their existing core network infrastructure while deploying 5G NR. Standalone (SA) 5G Core: in this option, both the radio access network and the core network use 5G technologies (5G NR and 5GC, respectively). This allows for the full feature set of 5G, including ultra-reliable low-latency communication (URLLC) and network slicing. Each type of packet core, and other types not mentioned above, supports different network technologies and has its own advantages and disadvantages in terms of performance, latency, and functionality.

In one embodiment, the system element 5processing is designed to utilize different types of data and clues associated with the remote mobile device 1RMD1. The data sets received from the Radio Access Network (RAN) 3BS and packet core 4PaCo provide various types of information or clues about the mobile device. These could include control information, traffic information, device identifiers, network protocol usage patterns, location data, sensor data, battery usage patterns, communication patterns, and application usage statistics. Element 5processing processes these data sets using at least one data processing technique, generating an output data set. This output data set is then used to determine at least one of three key aspects of the remote mobile device 1RMD1: Type: this may refer to the general category of the device, such as whether it's a smartphone 1phone1, an Internet of Things (IoT) device 1IoT1, a personal computer, a laptop 1PC1, or another type of mobile device. Model: the specific model of the device within its type. Manufacturer: the company or entity that produced the device. By processing and analyzing the different types of data and clues, the system can accurately and consistently determine the type (e.g., category), model, and manufacturer of the remote mobile device 1RMD1.

It is noted that the operator of element 5processing does not necessarily have direct contact with the remote mobile device 1RMD1. This means there is no visual contact or physical access to the device. Therefore, the operator cannot directly determine key factors such as the type, model, and manufacturer of the device. Instead, the operator relies on the data sets received from the RAN and packet core, which provide various types of information or clues about the mobile device. By processing and analyzing these data sets, the system can accurately and consistently determine the type (e.g., category), model, and manufacturer of the remote mobile device 1RMD1, despite the lack of direct contact.

It is noted that in the context of this disclosure, the term “type” when used in conjunction with a mobile device, is not limited to a singular definition. It encompasses a broad spectrum of characteristics that define the device. This includes, but is not limited to, the general category of the device (such as a phone or an IoT device), the specific model of the device, the manufacturer of the device, or any other characteristic associated with the device. Therefore, determining the “type” of a mobile device refers to the process of identifying one or more of these defining characteristics.

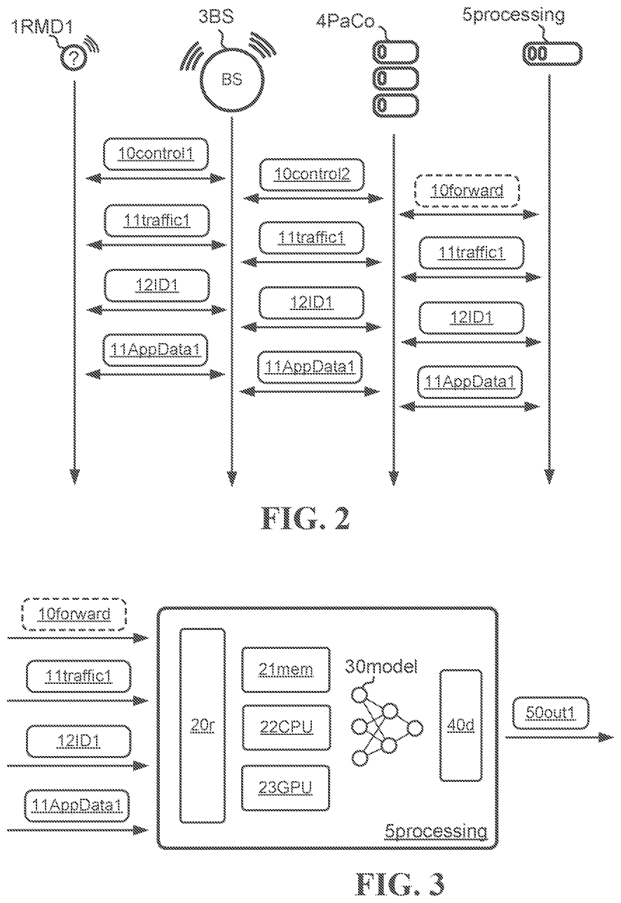

FIG. 2 illustrates one embodiment of conveying different types of data sets to be used for remotely determining the type of a mobile device. In this embodiment, multiple types of data sets, namely 10control1, 11traffic1, 12ID1, and 11AppData1, are received in conjunction with a remote mobile device RMD1 that is currently and/or was previously attached to RAN 3BS associated with a packet core 4PaCo. Each of these data sets comprises a respective type of information operative to provide at least one respective type of clue regarding the type of mobile device best describing the remote mobile device.

In one embodiment, the control data set 10control1 is issued by the RAN 3BS to directly control the remote mobile device RMD1, while the control data set 10control2 is issued by the packet core 4PaCo to control the RAN in conjunction with the remote mobile device RMD1 or to indirectly control the remote mobile device RMD1. These data sets are then relayed to a processing element 5processing through a process/data set represented as 10forward. For example, 10control1 could include commands issued by 3BS for adjusting the transmission power of the mobile device, or instructions for the mobile device to switch to a different frequency band or cell tower for better network connectivity, while 10control2 could include commands issued by 4PaCo for the RAN 3BS to allocate more resources to a particular mobile device during peak usage times, or instructions for the RAN to initiate a handover process for the mobile device to a different cell tower. It could also include commands sent to the mobile device via the RAN, such as instructions for the mobile device to update its system settings for network optimization.

In one embodiment, 11traffic1 refers to the traffic information data set associated with the remote mobile device 1RMD1. This data set could include various types of data related to the communication activities of the mobile device over the network. For example, it could include: packet payloads: this could include the actual data that the mobile device is sending or receiving over the network. IP addresses: these could be the source or destination IP addresses involved in the network communication of the mobile device. Ports: these could be the source or destination ports used by the mobile device for its network communication. Data volume statistics: this could include information about the amount of data the mobile device is sending or receiving over the network. Application-specific data patterns: this could include patterns in the data that are specific to certain applications used by the mobile device.

In one embodiment, 12ID1 refers to the device identity or identifiers data set associated with the remote mobile device. This data set could include various unique identifiers used for device identification in mobile networks. For example, it could include: International Mobile Equipment Identity (IMEI) numbers: these are unique numbers given to every mobile device for identification. International Mobile Subscriber Identity (IMSI) numbers: these are unique identifiers that are linked to the SIM card in a mobile device and are used to identify the user of a cellular network. Media Access Control (MAC) addresses: these are unique identifiers assigned to a network interface controller for communications at the data link layer of a network segment.

In one embodiment, 11AppData1 refers to the application data set associated with the remote mobile device 1RMD1. This data set could include various types of data related to the applications installed and used on the mobile device. For example, it could include: application usage statistics: this could include information about which applications are most frequently used on the device, how long each application is used, and at what times of day. Application-specific data: this could include data that is specific to certain applications, e.g., for a social media app, it could include the number of posts made, the number of friends or followers, etc. Installed applications: this could include a list of all applications that are currently installed on the device.

FIG. 3 illustrates one embodiment of a system operative to process multiple types of inputs to remotely determine mobile device type.

In one embodiment, receiver sub-system 20r is operative to receive at least two types of data sets associated with the remote mobile device. These data sets, which may include 10control/10forward, 11traffic1, 12ID1, and 11AppData1, are received in conjunction with the RAN 3BS associated with the packet core 4PaCo. Each data set provides a respective type of information that offers clues regarding the type of mobile device best describing the remote mobile device.

In one embodiment, the receiver sub-system 20r may be a component that interfaces with various communication networks to receive data sets. For example, cellular network interface: this could be a 4G LTE, 5G, or any other cellular network interface that allows the receiver sub-system to connect to the RAN and receive data sets. If the mobile device is connected to a Wi-Fi network, the receiver sub-system could include a Wi-Fi interface to receive data sets over this network. In a wired setup, an Ethernet interface could be used to receive data sets. The receiver sub-system 20r could also include an Internet interface. this interface would allow the receiver sub-system to connect to the Internet and receive data sets from the remote mobile device, RAN, and packet core over various Internet protocols, such as HTTP, FTP, or TCP/IP. Satellite network interface could be used to receive data sets as well. In one embodiment, the receiver sub-system 20r may include glue logic and processing elements to pre-process the data sets before further processing occurs in conjunction with processing the data sets.

In one embodiment, computer 22CPU, 23GPU includes a Central Processing Unit (CPU) 22CPU and a Graphics Processing Unit (GPU) 23GPU. The computer is responsible for executing machine-readable code and handling related data. It may operate in conjunction with a machine learning model 30model to process the received data sets.

In one embodiment, memory module 21mem is part of the computer and is used to store machine-readable code and related data. It may facilitate operation of the machine learning model.

In one embodiment, machine learning model 30model is configured to process the received data sets 10control/10forward, 11traffic1, 12ID1, and 11AppData1, thereby generating an output data set 50out1. The model may be associated with supervised learning, unsupervised learning, reinforcement learning, or deep learning. The model is trained on previously acquired data sets and fine-tuned based on evaluation results to optimize performance.

In one embodiment, determination component 40d is operative to determine the type of mobile device best describing the remote mobile device using the output data set. The determination is more accurate and/or more consistent than any similar determination using only one type of the data sets as an input. In one embodiment, the determination component 40d is responsible for making the final decision on the type of the remote mobile device based on the output data set generated by the machine learning model or generated otherwise. This component could use various decision-making algorithms or techniques depending on the specific requirements. For example: classification algorithms: if the types of mobile devices are predefined, the determination component could use classification algorithms such as Decision Trees, Naive Bayes, or Support Vector Machines to classify the remote mobile device into one of these predefined types. Clustering Algorithms: if the types of mobile devices are not predefined, the determination component could use clustering algorithms such as K-means or Hierarchical Clustering to group similar devices together and determine the type of the remote mobile device based on these groups. Rule-Based Systems: the determination component could also use a rule-based system where rules are defined for each type of mobile device. The type of the remote mobile device is then determined based on which rules it satisfies. Neural Networks: the determination component could use neural networks, as part of 30model or separately, to determine the type of the remote mobile device. These networks can learn and improve their accuracy over time.

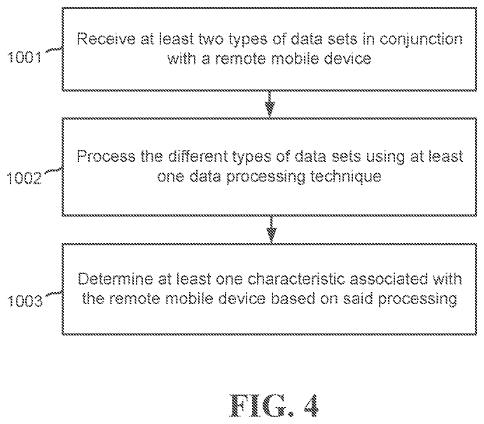

FIG. 4 illustrates one embodiment of a method for processing multiple types of inputs to remotely determine mobile device type, comprising: In step 1001, receiving, in conjunction with a Radio Access Network (RAN) 3BS (FIG. 1) associated with a packet core 4PaCo (FIG. 1), to which a remote mobile device 1RMD1 (FIG. 1) is currently and/or was previously attached, at least two types of data sets 10control1, 11traffic1, 12ID1, 11AppData1 (FIG. 2, in which four different types of data sets are shown) associated with the remote mobile device, in which each of the data sets received comprises a respective type of information operative to provide at least one respective type of clue regarding a type of mobile device best describing said remote mobile device.

In step 1002, processing 5processing (FIG. 2), using at least one data processing technique 30model (FIG. 3), the at least two types of data sets, thereby generating an output data set 50out1 (FIG. 3). In step 1003, determining 40d (FIG. 3), using at least said output data set, the type of mobile device best describing said remote mobile device; in which, as a direct result of said processing, the determination is more accurate and/or more consistent than any similar determination using only one of the at least two types of data sets as an input.

In one embodiment, the mobile device type (e.g., category) comprises at least one of: (i) smartphones 1phone1 (FIG. 1), (ii) tablets, (iii) feature phones, (iv) Internet of Things (IoT) devices 1IoT1 (FIG. 1), (v) personal computers and/or laptops 1PC1 (FIG. 1), (vi) notebooks, (vii) wearables, (viii) and any other portable and/or non-portable electronic device capable of wireless communication and network connectivity to the RAN 3BS and/or packet core 4PaCo.

In one embodiment, said determining 40d of the type of mobile device best describing said remote mobile device 1RMD1 comprises identifying at least one manufacturer 2MA, 2MA, 2MC (FIG. 1) associated with the remote mobile device.

In one embodiment, said determining of the type of mobile device best describing said remote mobile device 1RMD1 comprises identifying a specific model 1phone1a, 1phone1b, 1phone1c (FIG. 1) to which the remote mobile device belongs.

In one embodiment, the at least two types of data sets comprise at least any different two of: (i) traffic information 11traffic1 collected from the Radio Access Network (RAN) 3BS and the packet core 4PaCo, (ii) control information 10control1 collected from the Radio Access Network (RAN) and the packet core, (iii) device identifiers 12ID1 (iv) network protocol usage patterns, (v) location data, (vi) sensor data, (vii) battery usage patterns, (viii) communication patterns, and (ix) application usage statistics.

In one embodiment, the device identity/identifiers data type 12ID1 comprises at least one of the following unique identifiers associated with mobile devices: (i) international mobile equipment Identity (IMEI) numbers, (ii) international mobile subscriber Identity (IMSI) numbers, (iii) media access control (MAC) addresses, and (iv) any other persistent and globally unique identifiers used for device identification in mobile networks.

In one embodiment, the traffic information data type 11traffic1 comprises at least one of the following types of data associated with communication activities of mobile devices: (i) packet payloads, (ii) IP addresses, (iii) ports, (iv) data volume statistics, (v) application-specific data patterns, and (vi) any other information related to the content and/or characteristics of data transmissions over network.

In one embodiment, in addition to the aforementioned data types, the traffic information data set 11traffic1 can also include packet-specific characteristics, destinations of the packets, and session characteristics. For example: packet-specific characteristics could include patterns of packet lengths and time intervals between packets. Analyzing these patterns can provide insights into the nature of the network traffic and help identify specific types of network activities or behaviors. The destinations of the packets are another crucial piece of information. While IP addresses provide some information about the destinations, specific hostnames obtained using the DNS protocol can provide more detailed and meaningful information about the network locations that the mobile device is communicating with. Session characteristics could include the number of packets per session and TCP flags patterns. The number of packets per session can give an idea about the volume of data being transferred in each network session, while TCP flags patterns can provide insights into the control mechanisms of the network communication. By analyzing these additional types of data, the system can gain a deeper understanding of the mobile device's network behavior, which can further enhance the accuracy of the mobile device type determination.

In one embodiment, and in conjunction with said receiving, obtaining traffic information data types 11traffic1 comprises at least one of: (I) directly interacting with the mobile device 1RMD1 through network communication protocols, (ii) application programming interfacing (APIs), and (iii) utilizing other communication channels operative to collect traffic-related information, including at least one of packet payloads, IP addresses, ports, data volume statistics, and application-specific data patterns, without requiring internal access to the RAN 3BS or packet core 4PaCo infrastructure.

In one embodiment, in conjunction with the aforementioned paragraphs, obtaining traffic information data types 11traffic1 could also involve methods to passively or actively collect traffic information. This could include User-Plane and Control Plane: user-plane refers to the traffic (such as voice, data, and video) that a user intends to send or receive while control plane manages traffic (signaling) between networks and within networks. The system could monitor both user-plane and control plane data to gain a comprehensive view of the mobile device's network activity. Port Mirroring: this is a method used on network switches to send a copy of network packets seen on one switch port (or an entire VLAN) to a network monitoring connection on another switch port. This is commonly used for network appliances that require monitoring of network traffic, and could be used in this context to collect traffic information. These methods would provide additional ways to collect traffic information, enhancing the system's ability to accurately determine the type of a mobile device.

In the context of networking, SPAN stands for Switch Port Analyzer. It's a network protocol that collects and forwards switch traffic to the SPAN port for analysis. SPAN is used for troubleshooting connectivity issues and calculating network utilization and performance, among many others. In one embodiment, SPAN could be used to passively collect traffic information from the network switch. This could include packet-specific characteristics, destinations of the packets, and session characteristics. This information can then be used to assist in remotely determining the type of a mobile device.

In one embodiment, the control information data type 10control1 comprises at least one of the following types of data associated with the management and/or control of mobile network operations: (i) radio resource control (RRC) messages, (ii) mobility management messages, (iii) quality of service (QoS) parameters, (iv) handover signaling, and (v) any other signaling messages and/or metadata used for network management and/or device authentication and/or resource allocation.

In one embodiment, in conjunction with said receiving, the control data types 10control1 are obtained from internal sources within the RAN 3BS and/or the packet core 4PaCo of the mobile network infrastructure, in which the method further comprising: establishing communication with the RAN associated with the packet core; accessing internal sources within the RAN and/or packet core to obtain traffic control-related data types; and collecting traffic information from communication activities of the mobile device 1RMD1 through the established communication with the RAN. In one embodiment, SPAN, which stands for Switch Port Analyzer, or other routing, mirroring, and/or sampling techniques can be used to obtain the control data types 10control1.

In one embodiment, the processing 5processing of the data set types related to control 10control1 and data sets related to traffic 11traffic1 involves analyzing a correlation between control information comprising mobility management messages and/or quality of service parameters, and traffic information comprising packet payloads and/or IP addresses, to differentiate between device types based on their distinctive usage patterns and/or network behaviors.

In one embodiment, the processing 5processing of data set types related to control/traffic 10control1, 11traffic1, and data sets related to device identity 12ID1 comprises correlating the usage patterns and/or network behaviors derived from control and/or traffic data with the unique identifiers associated with each device, thereby enhancing the accuracy of distinguishing between device types based on their distinctive behavioral characteristics and/or device attributes.

In one embodiment, the processing 5processing of the at least two types of data sets 10control1, 11traffic1, 12ID1, 11AppData1 using at least one data processing technique involves employing algorithms comprising at least one of: (i) machine learning algorithms, (ii) statistical analysis methods, (iii) pattern recognition techniques, and (iv) data fusion approaches.

In one embodiment, the processing 5processing of the data sets received utilizes a machine learning model 30model (FIG. 3) trained on previously acquired data sets, wherein the machine learning model is associated with at least one of: (i) supervised learning, (ii) unsupervised learning, and/or (iii) reinforcement learning.

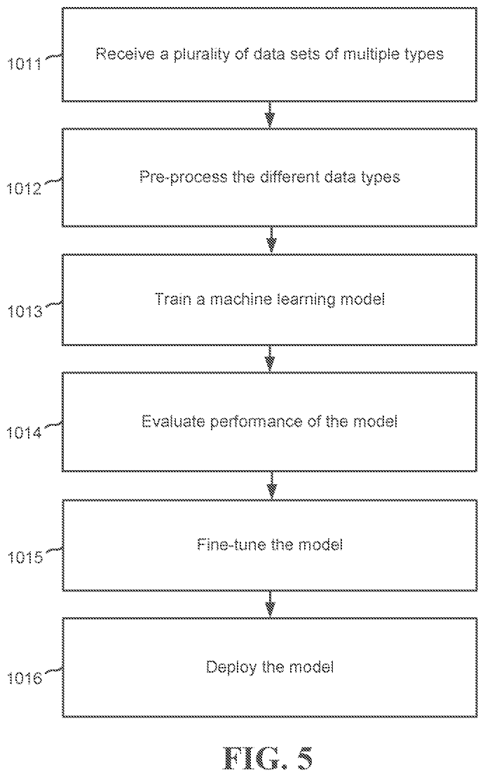

FIG. 5 illustrates one embodiment of a method for training and employing a machine learning model in conjunction with processing multiple types of inputs to remotely determine mobile device type, comprising: In step 1011, receiving, in conjunction with a radio access network (RAN) 3BS associated with a packet core 4PaCo to which multiple remote mobile devices 1RMD1, 1RMD2, 1RMDn (FIG. 1) are attached and/or were previously attached, a plurality of data sets 10control, 11traffic, 12ID, 11AppData comprising at least two types of data sets associated with the remote mobile devices, each containing information providing clues about the types of mobile devices. In step 1012, preprocessing, per each of the types separately, the received data sets to make them operative for training. In step 1013, training a suitable machine learning model 30model using the preprocessed data sets of the different types to discern patterns and correlations between different data features and mobile device types. In step 1014, evaluating a performance of the model trained using at least one validation technique. In step 1015, fine-tuning the model parameters and/or architecture based on the evaluation results to optimize performance. In step 1016, deploying the trained model for use in determining the type of mobile devices based on new incoming data sets 10control1, 11traffic1, 12ID1, 11AppData1 of different types.

In one embodiment, the preprocessing comprises at least one of: (i) data cleaning, (ii) feature extraction, and (iii) normalization.

In one embodiment, the machine learning model 30model is associated with at least one of: (i) supervised learning, (ii) unsupervised learning, (iii) reinforcement learning, and (iv) deep learning.

In one embodiment, the validation techniques comprise at least one of: (i) cross-validation and (ii) holdout validation.

One embodiment is a system operative to process multiple types of inputs to remotely determine mobile device type, comprising: a receiver sub-system 20r (FIG. 3) configured to receive, in conjunction with a radio access network (RAN) 3BS associated with a packet core 4PaCo, to which a remote mobile device 1RMD1 is currently and/or was previously attached, at least two types of data sets 10control1, 11traffic1, 12ID1, 11AppData1 associated with the remote mobile device, wherein each of the data sets received comprises a respective type of information operative to provide at least one respective type of clue regarding a type of mobile device best describing said remote mobile device; a computer 22CPU, 23GPU (FIG. 3) comprising a memory module 21mem (FIG. 3) operative to store machine-readable code and related data in conjunction with operating a machine learning model 30model configured to process 5processing the at least two types of data sets, thereby generating an output data set 50out1; and a determination component 40d (FIG. 3) configured to determine, using at least said output data set 50out1, the type of mobile device best describing said remote mobile device; wherein, as a direct result of said processing, the determination is more accurate and/or more consistent than any similar determination using only one of the at least two types of data sets as an input.

In one embodiment, the receiver sub-system 20r, the computer 22CPU, 23GPU comprising the memory module 21mem, and the determination component 40d are implemented in one or more of the following environments: (i) a local server, wherein the components are housed on a dedicated machine within the same network as the mobile devices, (ii) a cloud-based server, wherein the components are hosted on a virtual server in a remote data center and accessed over the internet, (iii) a hybrid server, wherein some components are hosted locally and others are hosted in the cloud, and (iv) a distributed server, wherein the components are spread across multiple machines or locations for load balancing or redundancy purposes.

According to one exemplary scenario, a remote mobile device 1RMD1 (FIG. 1) connects to a RAN 3BS (FIG. 1) associated with a packet core 4PaCo (FIG. 1). The system receives an identity data set 12ID1 (FIG. 2) associated with the remote mobile device. This data set includes an International Mobile Equipment Identity (IMEI) number, a unique identifier typically associated with mobile devices. Based on this IMEI number, the system initially identifies the remote mobile device as an Internet of Things (IoT) meter device. IoT meter devices often have specific ranges of IMEI numbers assigned to them, so this initial identification is a reasonable assumption. However, the system also receives a traffic data set 11traffic1 (FIG. 2) associated with the remote mobile device. This data set includes information about the data transmissions over the network, such as packet payloads, IP addresses, ports, and data volume statistics. Upon processing 5processing (FIG. 2) this traffic data set using a machine learning model 30model (FIG. 3), the system notices patterns that are inconsistent with typical IoT meter devices. For example, the volume and frequency of data transmissions are much higher than what would be expected from an IoT meter device. Furthermore, the system detects traffic associated with web browsing and video streaming, activities that are not characteristic of IoT meter devices. Based on this additional information, the system determines 40d (FIG. 3) that the remote mobile device is not an IoT meter device, but rather an impostor device, specifically a laptop. Laptops can also connect to mobile networks and can have IMEI numbers if they are equipped with cellular modems. The traffic patterns detected by the system are much more consistent with typical laptop usage. In this way, by combining multiple types of data sets (identity data and traffic data), the system can more accurately determine the type of a remote mobile device. This determination is more accurate and/or more consistent than any similar determination using only one type of data set as an input.

According to another exemplary scenario, a remote mobile device 1RMD1 (FIG. 1) connects to a RAN 3BS (FIG. 1) associated with a packet core 4PaCo (FIG. 1). The system receives a traffic data set 11traffic1 (FIG. 2) associated with the remote mobile device. This data set includes information about the data transmissions over the network, such as packet payloads, IP addresses, ports, and data volume statistics. Based on this traffic data set, the system initially identifies the remote mobile device as an Internet of Things (IoT) device, as the data transmissions are infrequent and of small volume, which is typical for many IoT devices. However, the system also receives a control data set 10control1 (FIG. 2) associated with the remote mobile device. This data set includes information about the management and/or control of mobile network operations, such as radio resource control (RRC) messages, mobility management messages, quality of service (QoS) parameters, handover signaling, and other signaling messages and/or metadata used for network management and/or device authentication and/or resource allocation. Upon processing 5processing (FIG. 2) this control data set using a machine learning model 30model (FIG. 3), the system notices patterns that are inconsistent with typical IoT devices. For example, the system detects frequent handover signaling, which indicates that the device is moving around a lot. This is not typical for most IoT devices, which are usually stationary. Based on this additional information, the system determines 40d (FIG. 3) that the remote mobile device is not an IoT device, but rather a personal computer. Personal computers can also connect to mobile networks if they are equipped with cellular modems, and the detected patterns of movement and data transmission are much more consistent with typical personal computer usage. In this way, by combining multiple types of data sets (traffic data and control data), the system can more accurately determine the type of a remote mobile device. This determination is more accurate and/or more consistent than any similar determination using only one type of data set as an input.

According to yet another exemplary scenario, a remote mobile device 1RMD1 (FIG. 1) connects to a RAN 3BS (FIG. 1) associated with a packet core 4PaCo (FIG. 1). The system receives four types of data sets associated with the remote mobile device: identity data set 12ID1 (FIG. 2), traffic data set 11traffic1 (FIG. 2), control data set 10control1 (FIG. 2), and application data set 11AppData1 (FIG. 2). Based on the IMEI number in the identity data set, the system initially identifies the remote mobile device as a mobile device. The traffic data set also shows patterns typical of a mobile device, such as frequent data transmissions and usage of mobile applications. However, the control data set reveals some inconsistencies. For example, the system detects infrequent handover signaling, which suggests that the device is stationary, a characteristic more typical of IoT devices. The application data set provides further clues. It shows that while mobile applications are being used, the usage patterns are unusual for a typical mobile device. For example, the system detects regular intervals of activity followed by long periods of inactivity, which is more characteristic of an IoT device programmed to perform specific tasks at set intervals. Upon processing 5processing (FIG. 2) all these data sets using a machine learning model 30model (FIG. 3), the system determines 40d (FIG. 3) that the remote mobile device is not a mobile device, but rather an IoT device trying to mimic a mobile device. In this way, by combining multiple types of data sets (identity data, traffic data, control data, and application data), the system can more accurately determine the type of a remote mobile device. This determination is more accurate and/or more consistent than any similar determination using only one or two types of data sets as an input.

In the first two exemplary scenarios, a heuristic data approach or a tabular logical data approach could potentially be used to reach the correct conclusion. These methods often involve using simple rules or decision trees based on the characteristics of the data. For example, if the traffic data shows infrequent data transmissions and usage of mobile applications, a heuristic or tabular approach might classify the device as an IoT device. Similarly, if the control data shows frequent handover signaling, the device might be classified as a mobile device. However, these methods have limitations. They are often based on predefined rules and lack the flexibility to adapt to new patterns in the data. They might work well for simple scenarios where the patterns are clear and consistent, but they can struggle with more complex scenarios where the patterns are subtle or variable. A well-trained complex model, on the other hand, can learn from the data and adapt to new patterns. It can consider multiple factors at once and understand how they interact with each other. This makes it more effective at detecting complex scenarios, like in the first two examples where the device type was determined based on multiple types of data sets. In the last scenario, which is more complex, a well-trained complex model is really mandatory to achieve good results. This scenario involves an IoT device trying to mimic a mobile device, which is a sophisticated behavior that would be difficult to detect with simple rules or heuristics. The complex model can analyze the data from multiple angles, consider the interactions between different types of data, and make a more accurate determination. In conclusion, while heuristic or tabular approaches can be useful in some cases, a well-trained complex model is often necessary to accurately determine the type of a remote mobile device, especially in complex scenarios.

In some embodiment, different methods for combining clues from various data set types can be used, perhaps in combinations, to determine the mobile device type: Rule-based Systems: these systems use a set of predefined rules to make decisions. For example, if the traffic data shows a certain pattern and the control data shows another pattern, the system might conclude that the device is of a certain type. Decision Trees: decision trees use a tree-like model of decisions. The system would ask a series of questions about the data sets, each question narrowing down the possible device types, until it arrives at a decision. Statistical Methods: these methods use statistical techniques like regression analysis or Bayesian inference to combine the data. The system might calculate the probability of each device type given the data sets, and choose the device type with the highest probability. Machine Learning: machine learning models can learn from examples to make decisions. The system could be trained on a large number of examples of different device types, each with their own data sets. Once trained, the system can predict the device type of new data sets. Deep Learning: deep learning is a type of machine learning that uses neural networks with many layers. These models are particularly good at handling complex patterns and high-dimensional data, making them well-suited for combining multiple types of data sets. Ensemble Methods: ensemble methods combine multiple machine learning models to make a decision. The system might use several different models, each trained on a different type of data set, and combine their predictions to determine the device type. Each of these methods has its own strengths and weaknesses, and the best choice depends on the specific characteristics of the data sets and the requirements of the task.

In an exemplary scenario, a remote mobile device 1RMD1 (FIG. 1) connects to a RAN 3BS (FIG. 1) associated with a packet core 4PaCo (FIG. 1). The system receives an identity data set 12ID1 (FIG. 2) and a traffic data set 11traffic1 (FIG. 2) associated with the remote mobile device. The identity data set includes an International Mobile Equipment Identity (IMEI) number, which can be used to identify the manufacturer of the device. However, some manufacturers may try to intentionally or unintentionally hide the IMEI number, or the IMEI number may simply not be available at the moment, making it difficult to determine the exact manufacturer. By also analyzing the traffic data set, which includes information about the data transmissions over the network, the system can identify unique patterns or characteristics associated with certain manufacturers, thereby accurately determining the manufacturer of the device. In another exemplary scenario, the system receives a control data set 10control1 (FIG. 2) and an application data set 11AppData1 (FIG. 2) associated with the remote mobile device. The control data set includes information about the management and/or control of mobile network operations, such as radio resource control (RRC) messages, mobility management messages, quality of service (QoS) parameters, handover signaling, and other signaling messages and/or metadata used for network management and/or device authentication and/or resource allocation. Different models of devices from a same manufacturer may handle these operations differently, allowing the system to narrow down the possible models. The application data set provides further clues. It shows the applications installed on the device and their usage patterns, which can vary significantly between different models. By combining these two types of data sets, the system can accurately determine the specific model of the device. In both scenarios, a single type of data set might not provide enough information to accurately determine the manufacturer or model of the device. By combining multiple types of data sets, the system can make a more accurate determination.

In one embodiment, the type determination is provide as a service to various clients, in which the service would work as follows: Mobile Number Inquiry: clients provide a mobile number for inquiry to the service provider. Data Collection: the service provider, having access to the necessary infrastructure and permissions, collects the various data types associated with the provided mobile number. This could include identity data, traffic data, control data, and application data. Data Processing: The collected data is processed in the cloud. This involves combining the different types of data sets using a machine learning model or other data processing techniques to generate an output data set. Device Type Determination: the service uses the output data set to determine the type of the mobile device associated with the provided mobile number. This determination is more accurate and/or more consistent than any similar determination using only one type of data set as an input. Results Delivery: the results of the device type determination are delivered back to the clients. This could be done through an API, a web dashboard, or other means depending on the clients' needs. Continuous Learning and Improvement: as more data is collected and more device type determinations are made, the service can continuously learn and improve its accuracy and consistency. In this way, clients can simply provide a mobile number and the service provider will handle the rest, delivering accurate and consistent device type determinations as a cloud service. This can be particularly useful for businesses that need to know the device types of their users but do not have the resources or permissions to collect and process the necessary data themselves.

In one embodiment, the system can be designed to intervene when it detects inconsistencies in the data that suggest a new device being interfaced with is not what it seems. Here's how this could work: Device Profiling: when a new device is interfaced with the system, it collects the various data types associated with the device. this could include identity data, traffic data, control data, and application data. Data Processing and Analysis: the collected data is processed and analyzed using a machine learning model or other data processing techniques. This analysis is used to generate a profile of the device, including its expected behaviors and characteristics. Anomaly Detection: the system monitors the device's activities and compares them to the device's profile. If the device exhibits behaviors that significantly deviate from its profile, it's flagged as an anomaly. Alert Generation: once an anomaly is detected, the system can generate an alert. This could be in the form of a warning message that is sent to the relevant parties. The message would detail the nature of the anomaly and provide information about the device in question. Intervention: upon receiving the alert, the relevant parties can take appropriate action. This might include disconnecting the device, conducting a more thorough investigation, or updating the system's security protocols. In this way, the system not only interfaces with new devices but also provides a level of security by alerting to potential impostor devices or devices that are not what they seem.

In one embodiment, the system can be designed to intervene when it detects inconsistencies in data of monitored mobile devices that suggest the device being investigated has malfunctioned, suffered a cyber attack, or is otherwise compromised. This could be implemented as follows: Anomaly Detection: the system continuously monitors the data sets associated with each device. Using the machine learning model, it establishes a baseline of normal behavior for each type of device. When the data shows a significant deviation from this baseline, it's flagged as an anomaly. Alert Generation: once an anomaly is detected, the system can generate an alert. This could be in the form of a warning message that is sent to the relevant parties. The message would detail the nature of the anomaly and provide information about the device in question. Investigation and Response: upon receiving the alert, the relevant parties can investigate further. They might choose to block the device from the network, request additional verification, or take other appropriate actions. Learning and Improvement: over time, the system learns from these interventions. It continuously updates its model to improve its accuracy in detecting anomalies and identifying device types. In this way, the system not only determines the type of a remote mobile device but also provides a level of security by alerting to potential harmful events.

In one embodiment, the processing 5processing (FIG. 2) can be done inside the packet core 4PaCo (FIG. 1). This is particularly useful in scenarios where data privacy and security are paramount, as it keeps all data within the confines of the packet core. This can work as follows: Data Collection: the packet core 4PaCo collects various types of data sets associated with the remote mobile device, including identity data, traffic data, control data, and application data. Data Sharing: these data sets can be shared within the packet core for processing. This internal sharing allows different components or modules within the packet core to access and analyze the data sets as needed. Data Processing: the processing is done within the packet core. This involves combining the different types of data sets using a machine learning model or other data processing techniques to generate an output data set. Device Type Determination: the packet core uses the output data set to determine the type of the mobile device. This determination is more accurate and/or more consistent than any similar determination using only one type of data set as an input. By performing the processing inside the packet core, the system can ensure that all data remains within a controlled environment, enhancing data security and privacy. This approach might be particularly suitable for sensitive applications or for compliance with strict data protection regulations.

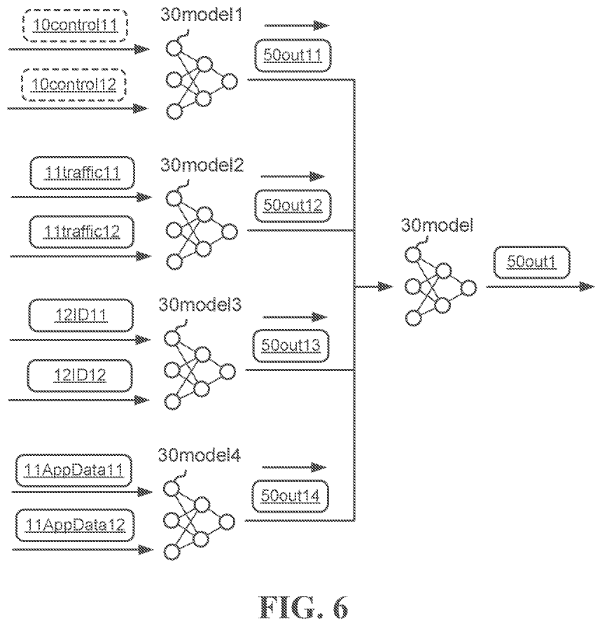

FIG. 6 illustrates one embodiment of a multi-stage processing method where each category of input data sets is processed by its respective model, and then a final model processes all the intermediary results to determine the type of mobile device. This method allows for a more accurate and/or consistent determination of the mobile device type compared to methods using only one type of data set as an input.

The system in FIG. 6 is operative to process multiple types of inputs to remotely determine mobile device type. The figure shows four categories of input data sets, each associated with different models, and a final model that processes the intermediary results of the previous models.

A plurality of input categories: the four exemplary input categories are 10control11 and 10control12, 11traffic11 and 11traffic12, 12ID11 and 12ID12, and 11AppData11 and 11AppData12, in which each of the input categories comprises, by way of example, two sub-categories, wherein each sub-category includes data sets associated with the remote mobile devices. Each data set contains information that provides clues about the types of mobile devices.

Individual Models: each input category is connected to its respective model, labeled as 30model1, 30model2, 30model3, and 30model4. These models process the respective input data sets and generate output data sets labeled as 50out11, 50out12, 50out13, and 50out14. Each model represents a specific processing or transformation function, in accordance with some embodiments, that is designed to discern patterns and correlations within its respective input data set.

Final Model: all four output data sets from the individual models are collectively linked to another model 30model. This final model processes the intermediary results of the previous models and generates the final output data set 50out1. This final model integrates the insights derived from the individual models and makes the final determination of the type of mobile device.

10control1: this category refers to control information collected from the Radio Access Network (RAN) and the packet core. Two sub-categories could be 10control11 and 10control12, which might represent different types of control information. For example, 10control11 could represent radio resource control (RRC) messages and mobility management messages, while 10control12 could represent quality of service (QoS) parameters and handover signaling.

11traffic1: this category refers to traffic information collected from the RAN and the packet core. Two sub-categories, 11traffic11 and 11traffic12, could represent different types of traffic information. For example, 11traffic11 might represent traffic information related to packet payloads and IP addresses, while 11traffic12 might represent information related to ports and data volume statistics.

12ID1: this category refers to device identifiers. Two sub-categories could be 12TD11 and 12ID12, which might represent different types of device identifiers. For example, 12ID11 could represent international mobile equipment Identity (IMEI) numbers and international mobile subscriber Identity (IMSI) numbers, while 12ID12 could represent media access control (MAC) addresses and other unique identifiers.

11AppData1: this category could refer to application usage statistics. Two sub-categories, 11AppData11 and 11AppData12, might represent different types of application data. For example, 11AppData11 could represent data related to the usage patterns of specific applications, while 11AppData12 could represent data related to the frequency and duration of application usage.

In one embodiment, the system may analyze data sets associated with a Non-Access Stratum (NAS) protocol. According to one example, the attach request and the User Equipment (UE) capability info indication are analyzed. These messages provide valuable information about the mobile device. For example, if the mobile device, also known as UE, reports to the Mobility Management Entity (MME) that Assisted Global Positioning System (AGPS) is supported, it may indicate that the device is not a specific brand of mobile device. This could be categorized as a control information data set 10control that is being analyzed in accordance with some embodiments. Another example is the number of supported radio bands. A phone, being a multipurpose device, will support many bands, while a Customer Premises Equipment (CPE), being a single-purpose device, will support fewer bands. In one embodiment, a large plurality of data points are accumulated over time in conjunction with the NAS protocol analysis, thereby adding certainty to the determination of identity and category associated with certain mobile devices. In one embodiment, over 100 data points are accumulated per a specific mobile device. In one embodiment, the plurality of data points are accumulated over a period of more than a week.

In one embodiment, when analyzing the International Mobile Equipment Identity (IMEI) of the mobile device, i.e., analyzing identity data sets 12ID in accordance with some embodiments, an inner structure of the IMEI may be utilized in several ways. The IMEI is a unique identifier for a mobile device and its format includes a Type Allocation Code (TAC) and a Serial Number (SNR). While the TAC can be looked up in databases like the GSMA DB to identify a specific modem type/model/brand associated with the mobile device, it may not always correctly represent the actual device using the modem. Therefore, the system also analyzes patterns in the SNR to determine which device is using the modem, a method referred to as IMEI similarity.

In one embodiment, Data Path Analysis may be applied, wherein the data path, which includes IPs, Ports, Domain Name System (DNS) queries, user agents, etc., is analyzed. This information can provide additional clues about the mobile device type. For example, certain IP addresses or user agents might be associated with specific types of devices. This could be categorized as traffic data set 11traffic analysis in accordance with some embodiments.

In one embodiment, Metadata Analysis is applied, which involves analyzing the number of packets in a flow, specific packet sizes, the number of flows, the direction of the flow (i.e., who is initiating the flow), and more. This additional layer of analysis may further enhance the ability to accurately identify and categorize remote mobile devices, and in accordance with some embodiments associated with traffic data set 11traffic analysis.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

Any process and/or step disclosed herein can be realized as a program, code, and/or executable instructions, to be executed by a computer, several computers, servers, logic circuits, etc. This includes, but is not limited to, any system, method, or apparatus disclosed herein.

Various processes or steps may be embodied as a non-transitory computer readable storage medium that stores the program, code, and/or executable instructions. This medium may include any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions.

The non-transitory computer readable medium or media may be transportable, such that the program or programs stored thereon may be loaded onto one or more different computers or other processors to implement various aspects described above. In some embodiments, the program, code, and/or executable instructions may be loaded electronically, e.g., via a network, into the non-transitory computer readable medium or media.

What is claimed is:

1. A method for processing multiple types of inputs to remotely determine mobile device type, comprising:
receiving, in conjunction with a radio access network (RAN) associated with a packet core, to which a remote mobile device is currently and/or was previously attached, at least two types of data sets associated with the remote mobile device, in which each of the data sets received comprises a respective type of information operative to provide at least one respective type of clue regarding a type of mobile device best describing said remote mobile device;
processing, using at least one data processing technique, the at least two types of data sets, thereby generating an output data set; and
determining, using at least said output data set, the type of mobile device best describing said remote mobile device;
whereby, as a direct result of said processing, the determination is more accurate and/or more consistent than any similar determination using only one of the at least two types of data sets as an input.

2. The method of claim 1, wherein the mobile device type comprises at least one of: (i) smartphones, (ii) tablets, (iii) feature phones, (iv) Internet of Things (IoT) devices, (v) personal computers and/or laptops, (vi) notebooks, (vii) wearables, and (viii) any other portable and/or non-portable electronic device capable of wireless communication and network connectivity to the RAN and/or packet core.

3. The method of claim 1, wherein said determining of the type of mobile device best describing said remote mobile device comprises identifying at least one manufacturer associated with the remote mobile device.

4. The method of claim 1, wherein said determining of the type of mobile device best describing said remote mobile device comprises identifying a specific model to which the remote mobile device belongs.

5. The method of claim 1, wherein the at least two types of data sets comprise at least one of: (i) traffic information collected from the Radio Access Network (RAN) and the packet core, (ii) control information collected from the Radio Access Network (RAN) and the packet core, (iii) device identifiers, (iv) network protocol usage patterns, (v) location data, (vi) sensor data, (vii) battery usage patterns, (viii) communication patterns, and (ix) application usage statistics.

6. The method of claim 1, wherein one of the types of data sets is associated with a device identity/identifiers data type comprising at least one of the following unique identifiers: (i) international mobile equipment identity (IMEI) numbers, (ii) international mobile subscriber Identity (IMSI) numbers, (iii) media access control (MAC) addresses, and (iv) any other persistent and globally unique identifiers used for device identification in mobile networks.

7. The method of claim 1, wherein one of the types of data sets is associated with a traffic information data type comprising at least one of the following types of data related to communication activities of mobile devices: (i) packet payloads, (ii) IP addresses, (iii) ports, (iv) data volume statistics, (v) application-specific data patterns, and (vi) any other information related to content and/or characteristics of data transmissions over a network.

8. The method of claim 7, wherein in conjunction with said receiving, obtaining the traffic information data types comprises at least one of: (I) directly interacting with the mobile device through network communication protocols, (ii) application programming interfacing (APIs), and (iii) utilizing other communication channels operative to collect traffic-related information, including at least one of packet payloads, IP addresses, ports, data volume statistics, and application-specific data patterns, without requiring internal access to the RAN or packet core infrastructure.

9. The method of claim 1, wherein one of the types of data sets is associated with a control information data type comprising at least one of the following types of data related to management and/or control of mobile network operations: (i) radio resource control (RRC) messages, (ii) mobility management messages, (iii) quality of service (QoS) parameters, (iv) handover signaling, and (v) any other signaling messages and/or metadata used for network management and/or device authentication and/or resource allocation.

10. The method of claim 9, wherein in conjunction with said receiving, the control information data types are obtained from internal sources within the RAN and/or the packet core of mobile network infrastructure, in which the method further comprising:
establishing communication with the RAN associated with the packet core;
accessing internal sources within the RAN and/or packet core to obtain traffic control-related data types; and
collecting traffic information from communication activities of the mobile device through the established communication with the RAN.

11. The method of claim 1, wherein the processing of the data set types related to control and data sets related to traffic involves analyzing a correlation between control information comprising mobility management messages and/or quality of service parameters, and traffic information comprising packet payloads and/or IP addresses, to differentiate between device types based on their distinctive usage patterns and/or network behaviors.

12. The method of claim 1, wherein the processing of data set types related to control/traffic and data sets related to device identity comprises correlating the usage patterns and/or network behaviors derived from control and/or traffic data with unique identifiers associated with each device, thereby enhancing accuracy of distinguishing between device types based on their distinctive behavioral characteristics and/or device attributes.

13. The method of claim 1, wherein the processing of the at least two types of data sets using at least one data processing technique involves employing algorithms comprising at least one of: (i) machine learning algorithms, (ii) statistical analysis methods, (iii) pattern recognition techniques, and (iv) data fusion approaches.

14. The method of claim 1, wherein the processing of the data sets received utilizes a machine learning model trained on previously acquired data sets, wherein the machine learning model is associated with at least one of: (i) supervised learning, (ii) unsupervised learning, or (iii) reinforcement learning.

15. A method for training and employing a machine learning model in conjunction with processing multiple types of inputs to remotely determine mobile device type, comprising:
receiving, in conjunction with a radio access network (RAN) associated with a packet core to which multiple remote mobile devices are attached and/or were previously attached, a plurality of data sets comprising at least two types of data sets associated with the remote mobile devices, each containing information providing clues about the types of mobile devices;
preprocessing, per each of the types separately, the received data sets to make them operative for training;
training a suitable machine learning model, using the preprocessed data sets of the types, to discern patterns and correlations between different data features and mobile device types;
evaluating a performance of the model trained using at least one validation technique;
fine-tuning parameters of the model and/or architecture based on the evaluation results to optimize performance; and
deploying the model trained for use in determining the type of mobile devices based on new incoming data sets of different types.

16. The method of claim 15, wherein the preprocessing comprises at least one of: (i) data cleaning, (ii) feature extraction, and (iii) normalization.

17. The method of claim 15, wherein the machine learning model is associated with at least one of: (i) supervised learning, (ii) unsupervised learning, (iii) reinforcement learning, and (iv) deep learning.

18. The method of claim 15, wherein the validation techniques comprise at least one of: (i) cross-validation, and (ii) holdout validation.

19. A system operative to process multiple types of inputs to remotely determine mobile device type, comprising:
a receiver sub-system configured to receive, in conjunction with a radio access network (RAN) associated with a packet core, to which a remote mobile device is currently and/or was previously attached, at least two types of data sets associated with the remote mobile device, wherein each of the data sets received comprises a respective type of information operative to provide at least one respective type of clue regarding a type of mobile device best describing said remote mobile device;
a computer comprising a memory module operative to store machine-readable code and related data in conjunction with operating a machine learning model configured to process the at least two types of data sets, thereby generating an output data set; and
a determination component configured to determine, using at least said output data set, the type of mobile device best describing said remote mobile device;
whereby, as a direct result of said processing, the determination is more accurate and/or more consistent than any similar determination using only one of the at least two types of data sets as an input.

20. The system of claim 19, wherein the receiver sub-system, the computer comprising the memory module, and the determination component are implemented in one or more of the following environments: (i) a local server, wherein the components are housed on a dedicated machine within the same network as the mobile devices, (ii) a cloud-based server, wherein the components are hosted on a virtual server in a remote data center and accessed over the internet, (iii) a hybrid server, wherein some components are hosted locally and others are hosted in the cloud, and (iv) a distributed server, wherein the components are spread across multiple machines or locations for load balancing or redundancy purposes.
